(19) United States
(12) Patent Application Publication
(10) Pub. No.: US 2024/0257171 A1
(43) Pub. Date: Aug. 1, 2024

(54) DATASET AND MODEL EXCHANGE FOR MACHINE LEARNING PREDICTION

(71) Applicant: International Business Machines Corporation, Armonk, NY (US)

(72) Inventors: Rakesh Rameshrao Pimplikar, Bangalore (IN); Ritwik Chaudhuri, Bangalore (IN); Kushal Mukherjee, New Delhi (IN); Gyana Ranjan Parija, Gurgaon (IN); Tatiana De Campovilla Trevisan, Vnhedo (BR); Prasant Parida, New Brunswick, NJ (US); Jill Harsh Roberts, Superior, CO (US)

(21) Appl. No.: 18/159,751

(22) Filed: Jan. 26, 2023

(51) Int. Cl. G06N 5/022

(52) U.S. Cl. CPC G06Q 30/0206; G06Q 30/0282

(57) ABSTRACT

A computer-implemented method includes publishing a prediction task and KPI information. The method further includes receiving, at a certain time, a plurality of prediction results, each of the plurality of prediction results being produced by one of a plurality of participants with one of a private model and private data association with the one of the plurality of participants. The method further includes calculating, for each of the plurality of participants, a trade score based on the KPI information and the plurality of prediction results for each of the plurality of participants. The method further includes determining an acquirement score for the one of the private model and the private data associated with each of the plurality of participants using the corresponding trade score. The method further includes publishing the acquirement score for trading the one of the private model and the private data among the plurality of participants.

### BACKGROUND

Embodiments described herein generally relate to processing systems, and more specifically, to dataset and model exchange for machine learning prediction.

Machine learning broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” and/or “trained machine learning model”) can be used to perform a task, such as to make a prediction for example.

### SUMMARY

In one exemplary embodiment, a computer-implemented method for collaborative exchange is provided. The method includes publishing a prediction task and key performance indicator (KPI) information. The method further includes receiving, at a certain time, a plurality of prediction results, each of the plurality of prediction results being produced by one of a plurality of participants with one of a private model and private data association with the one of the plurality of participants. The method further includes calculating, for each of the plurality of participants, a trade score based on the KPI information and the plurality of prediction results for each of the plurality of participants. The method further includes determining an acquirement score for the one of the private model and the private data associated with each of the plurality of participants using the corresponding trade score. The method further includes publishing the acquirement score for trading the one of the private model and the private data among the plurality of participants.

Other embodiments described herein implement features of the above-described method in computer systems and computer program products.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of a processing system for implementing one or more embodiments described herein;

FIG. 2 depicts a block diagram of components of a machine learning training and inference system according to one or more embodiments described herein;

FIG. 3 depicts a block diagram of an exchange system according to one or more embodiments described herein;

FIG. 4 depicts a flow diagram of a system flow for the exchange system of FIG. 3 according to one or more embodiments described herein;

FIG. 5 depicts a flow diagram of a method for dataset and model exchange for machine learning prediction is provided according to one or more embodiments described herein;

FIG. 6A depicts an example ecosystem for price prediction using the collaborative prediction platform of FIG. 3 according to one or more embodiments described herein;

FIG. 6B depicts an example ecosystem for contingent labor involving three agents according to one or more embodiments described herein;

FIG. 7 shows an example for feature exchange according to one or more embodiments described herein; and

FIGS. 8A, 8B, 8C, and 8D depict example graphs according to one or more embodiments described herein.

The diagrams depicted herein are illustrative. There can be many variations to the diagram or the operations described therein without departing from the scope of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

One or more embodiments of the described herein provide for dataset and model exchange for machine learning prediction.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as dataset and model exchange for machine learning prediction 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

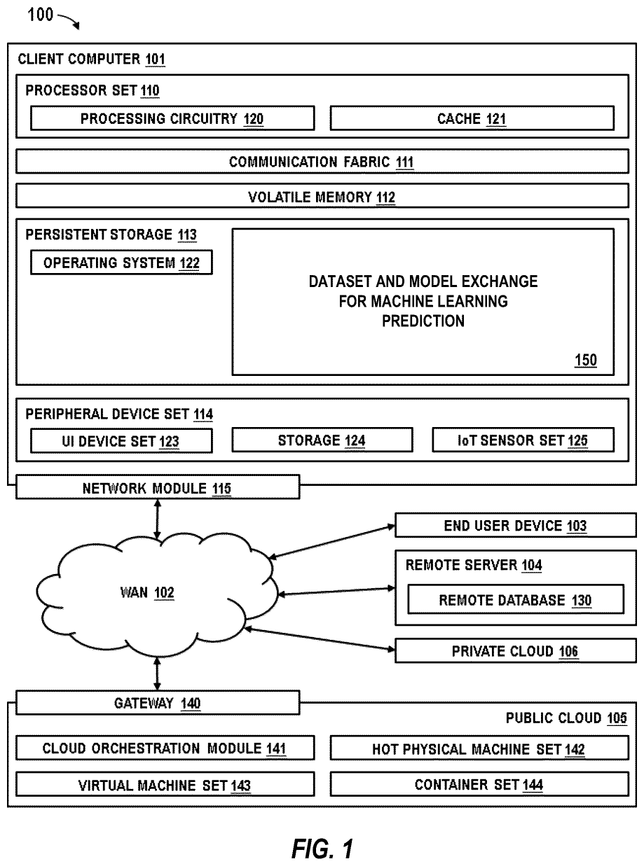

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

One or more embodiments described herein can utilize machine learning techniques to perform tasks, such as making predictions. More specifically, one or more embodiments described herein can incorporate and utilize rule-based decision making and artificial intelligence (AI) reasoning to accomplish the various operations described herein, namely making predictions. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” and/or “trained machine learning model”) can be used for making predictions, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques can be applied in the case of making predictions as described herein.

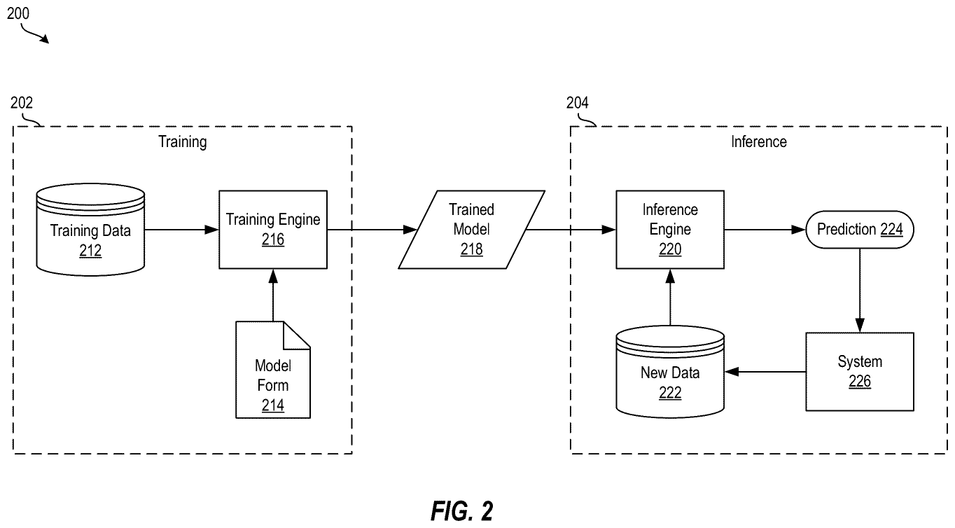

Systems for training and using a machine learning model are now described in more detail with reference to FIG. 2. Particularly, FIG. 2 depicts a block diagram of components of a machine learning training and inference system 200 according to one or more embodiments described herein. The system 200 performs training 202 and inference 204. During training 202, a training engine 216 trains a model (e.g., the trained model 218) to perform a task, such as to making predictions. Inference 204 is the process of implementing the trained model 218 to perform the task, such as to making prediction, in the context of a larger system (e.g., a system 226). All or a portion of the system 200 shown in FIG. 2 can be implemented, for example by all or a subset of the computing environment 100 of FIG. 1.

The training 202 begins with training data 212, which may be structured or unstructured data. According to one or more embodiments described herein, the training data 212 includes making predictions. The training engine 216 receives the training data 212 and a model form 214. The model form 214 represents a base model that is untrained. The model form 214 can have preset weights and biases, which can be adjusted during training. It should be appreciated that the model form 214 can be selected from many different model forms depending on the task to be performed. For example, where the training 202 is to train a model to perform image classification, the model form 214 may be a model form of a CNN. The training 202 can be supervised learning, semi-supervised learning, unsupervised learning, reinforcement learning, and/or the like, including combinations and/or multiples thereof. For example, supervised learning can be used to train a machine learning model to classify an object of interest in an image. To do this, the training data 212 includes labeled images, including images of the object of interest with associated labels (ground truth) and other images that do not include the object of interest with associated labels. In this example, the training engine 216 takes as input a training image from the training data 212, makes a prediction for classifying the image, and compares the prediction to the known label. The training engine 216 then adjusts weights and/or biases of the model based on results of the comparison, such as by using backpropagation. The training 202 may be performed multiple times (referred to as “epochs”) until a suitable model is trained (e.g., the trained model 218).

Once trained, the trained model 218 can be used to perform inference 204 to perform a task, such as to make predictions. The inference engine 220 applies the trained model 218 to new data 222 (e.g., real-world, non-training data). For example, if the trained model 218 is trained to classify images of a particular object, such as a chair, the new data 222 can be an image of a chair that was not part of the training data 212. In this way, the new data 222 represents data to which the model 218 has not been exposed. The inference engine 220 makes a prediction 224 (e.g., a classification of an object in an image of the new data 222) and passes the prediction 224 to the system 226 (e.g., the computing environment 100 of FIG. 1). The system 226 can, based on the prediction 224, take an action, perform an operation, perform an analysis, and/or the like, including combinations and/or multiples thereof. In some embodiments, the system 226 can add to and/or modify the new data 222 based on the prediction 224.

In accordance with one or more embodiments, the predictions 224 generated by the inference engine 220 are periodically monitored and verified to ensure that the inference engine 220 is operating as expected. Based on the verification, additional training 202 may occur using the trained model 218 as the starting point. The additional training 202 may include all or a subset of the original training data 212 and/or new training data 212. In accordance with one or more embodiments, the training 202 includes updating the trained model 218 to account for changes in expected input data.

For prediction problems, a lack of data for training can lead to poor predictions. In some situations, the relevant datasets or features that are used for predictions are not available to be used as training data and hence producing a prediction becomes a challenging task. For example, medical data may be difficult to collect and/or may have privacy issues associated therewith, making the data unavailable for use as training data.

Conversely, in other situations, relevant datasets which could have been used for training data for making predictions are available but owned by some other entity. In these cases, datasets might be acquired from such entity for training purposes. Often, there may be a cost associated with such data acquisition.

However, varieties of datasets with different features of the same prediction problem are often owned by different entities. Such private datasets are usually difficult to be acquired altogether to enhance the quality of prediction. More specifically, the entity training a machine learning model to make a prediction may not know whether these datasets will help enhance the predictions or not until after the datasets are acquired and used. Due to such uncertainties, often the entity training the machine learning model does not acquire datasets from other entities and/or acquires such datasets from entities that are known to be reputable.

These challenges cause the process of acquiring training data and training machine learning models to make predictions to be time consuming and slow.

Conventional approaches to collaboration may include federated learning, crowd sourcing, or others. However, these approaches are inadequate. For example, federated learning features are not shared/traded between participants, the same model is used among the participants, the incentive always comes from the orchestrator without any peer-to-peer incentive-based mechanism, the notion of incentives is based on a public utility which is being shared among participants. In crowd sourcing, the entire process is centrally monitored, there is no notion of sharing of knowledge among participants, and the participants cannot improve their KPIs over time.

In contrast to these approaches, one or more embodiments described herein, which may be referred to as knowledge trading, provide advantages over the shortcomings of federated learning and crowd sourcing, among others. In embodiments, participating agents trade data features (e.g., columns with data) among each other. Also, in embodiments, participators share decisions/outcome of their individual models in the form of predictions which is not done in federated learning. In embodiments, each participant uses the best model that produces the most accurate results with each of their data. Hence, in embodiments, each participant's models can be different from each other which is not the case in federated learning. In embodiments, a peer-to-peer incentive based mechanism exist as the participants trade data features with each other which are priced dynamically whenever the trading window/market opens up for trading. Such peer-to-peer incentive based mechanism is not there in federated learning. In embodiments, in a peer-to-peer trading, the incentive can be negative as well if a procured feature with a higher cost do not return a higher amount of accuracy and in turn fetches less profit based on the accuracy as compared to the amount at which the feature was procured. In embodiments, out of the entire utility, a portion of it can be a public utility, which is essentially being shared among peers and the rest is a private utility which represents the profit made through trading of data features among the participants. The private utility helps improve the public utility over time. In embodiments, the collaborative approach of feature/model exchange is decentralized. In embodiments, knowledge is shared using privately owned data in an efficient and effective way. In embodiments, the collaborative approach assists participants with improving their own KPIs over a period of time. In embodiments, every participant agent can learn about additional data portions/features/models other agents are using. Through selective trading of data portions/features in every round, a participant can improve its prediction model in subsequent rounds to get better incentives. These and other advantages are also possible.

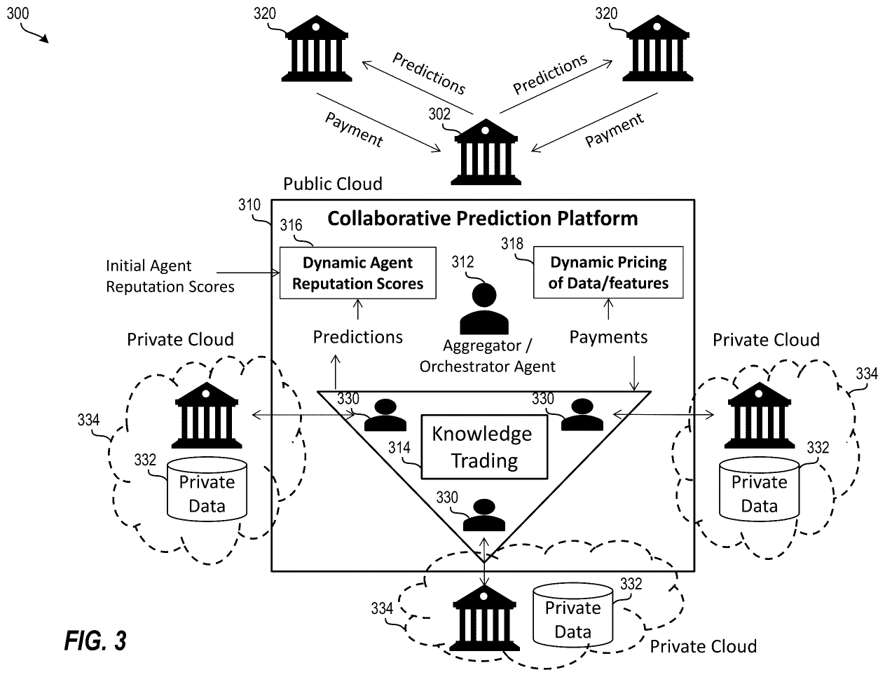

It can be difficult to share privately owned data across organizations in a collaborative environment for a prediction problem for various reasons. For example, an organization that owns private data does not necessarily know what data other organizations have and what additional data they may find useful and for what purpose, based on the prediction problem provided by a consumer organization, which is described further herein, for example consumer organizations 320 in FIG. 3. As another example, an organization who needs data to solve the prediction problem posted by the consumer organization also may not know which other organizations have that data/complementary data. Further, it can be difficult to come up with a price tag for a small portion of data or individual features in a collaborative set up. Also, the pricing of data portions/features is dynamic because it changes based on the prediction problem and the data owned by the other parties. The same portion of data may have different prices for different predictions problems. It is a challenge for an organization to decide whether to buy a portion of data/feature from another organization because it is difficult to measure the eventual profit margin after multiple trades and the final incentive from the orchestrator agent, which is described further herein, for example the aggregator/orchestrator agent 312 in FIG. 3.

One or more embodiments described herein address these and other shortcomings by providing for dataset and model exchange for machine learning prediction. According to one or more embodiments described herein, a platform is provided where multiple agents can onboard experts/agents from multiple entities that own or control datasets that may be useful as training data and then produce predictions and take part in dataset/feature exchange among the entities to enhance the accuracy of their predictions.

One or more embodiments described herein provide an exchange that facilitates collaboration among multiple agents (e.g., entities) and provides one or more of the following features. An orchestrator agent can announce that it needs predictions for a certain purpose and the associated key performance indicators (KPI) translated into profit. Multiple expert organizations that have privately-owned partial datasets that can be relevant for such a prediction problem can take part in the process and produce their individual predictions using privately owned models and pass it onto the agent. The orchestrator agent can translate multiple predictions from multiple organizations to a single prediction, and once the KPI is realized, then pass on profit based on the KPI to the expert organizations. A feature trading mechanism can be provided among expert organizations/agents so that the features can be procured and hence can be used for enhancing individual predictions coming from expert agents.

FIG. 3 depicts a block diagram of an exchange system 300 according to one or more embodiments described herein. According to one or more embodiments described herein, one or more aspects of the exchange system 300 can be implemented using the computing environment 100 of FIG. 1. The exchange system 300 can be used to facilitate exchange of datasets/features (e.g., data that can be used to train a machine learning model) and/or exchange of models (e.g., models that have previously been trained to perform a certain prediction, for example).

According to one or more embodiments described herein, a facilitator organization 302 facilitates an exchange of datasets (e.g., features) and/or models between agents, such as expert agents 330 to improve predictions of machine learning models.

The exchange system 300 includes a collaborative prediction platform 310. In this example, entities such as consumer organizations 320 provide payments or other remuneration in exchange for predictions. That is, the consumer organizations 320 pay for predictions from the collaborative prediction platform 310. The predictions are based on datasets (or “features”) acquired from expert agents 330. Each of the expert agents 330 can have private data 332 (and/or models) associated therewith, which can be stored in a private cloud 334, for example.

The collaborative prediction platform 310 includes an aggregator/orchestrator agent 312 to facilitate collecting the private data 332 from one or more of the expert agents 330 and to facilitate providing predictions to the consumer organizations 320. According to one or more embodiments described herein, the collaborative prediction platform 310 facilitates knowledge trading among the expert agents 330 at block 314. According to one or more embodiments described herein, the collaborative prediction platform 310 determines dynamic agent reputation scores for the expert agents 330 at block 316 based on, for example, predictions generated using the private data 332 associated with the expert agents 330 and an initial agent reputation score. According to one or more embodiments described herein, the collaborative prediction platform 310 also determines dynamic pricing of data/features (e.g., the private data 332) at block 318.

An example for using a knowledge catalog, such as the Watson Knowledge Catalog (WKC) from IBM Corporation, is now described. In exchange system 300, the facilitator organization 302 can be IBM and the platform used by the facilitator can be IBM Watson Knowledge Catalog in Watson Studio. WKC can be used for various purposes including data accessing and data sharing. According to one or more embodiments described herein, data governance is tightly coupled with WKC. WKC also maintains a catalog of datasets which can be used by the user to search for datasets. The expert agents 330 can have their individual accounts in WKC and can load their individually owned datasets (e.g., the private data 332) in WKC in their respective private clouds 334. Also, each expert agent 330 can be an expert who produces a prediction by analyzing its respective private data 332. The aggregator/orchestrator agent 312 (e.g., IBM) can aggregate the results obtained from the individual expert agents 330. Also, the exchange system 300 provides for the agents to share the individually owned data to another entity or agent. The aggregator/orchestrator agent 312 can pass the final aggregated result to the consumer organizations 320 who consumes the results to fulfill their own purposes and reward each individual expert agent 330 based on the prediction accuracy. Also, each of the individual expert agents can give access to portions of their privately owned dataset to another expert agent, such as after making an efficient trade with the recipient organization.

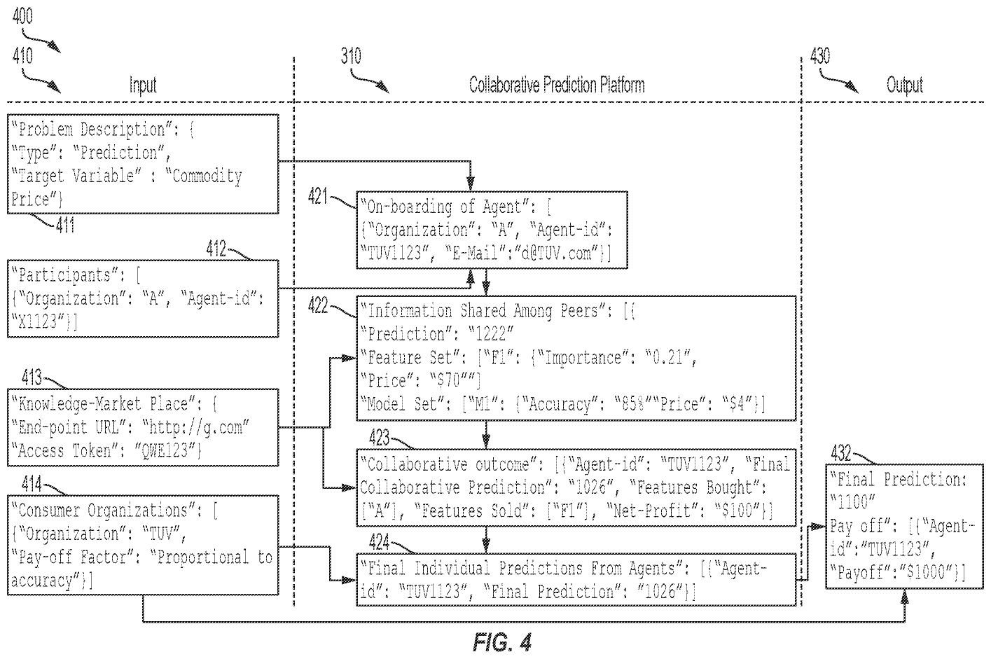

FIG. 4 depicts a flow diagram of a system flow 400 for the exchange system 300 of FIG. 3 according to one or more embodiments described herein. In this example, input 410 are input into the collaborative prediction platform 310, which generates outputs 430. The inputs 410 define a problem description 411, participants 412 (e.g., expert organizations or expect agents), a knowledge marketplace 413, and consumer organizations 414.

The collaborative prediction platform 310 uses the inputs to facilitate onboarding of expert agents 421, facilitate information shared among peers 422, predict a collaborative outcome 423, and generate final individual predictions from expert agents 424. Facilitating onboarding of agents 421 is based on the problem description 411 and the participants 412, for example. Facilitating information shared among peers 422 is based on the onboarding of agents 421 and the knowledge marketplace 413, for example. Predicting a collaborative outcome 423 is based on facilitating information shared among peers 422 and the knowledge marketplace 413, for example. Generating the final individual predictions from agents 424 is based on predicting a collaborative outcome 423 and the consumer organizations 414, for example.

The collaborative prediction platform 310 generates the output 430, which can include a final prediction 432. The final prediction 432 is based on the final individual predictions from agents 424 and the consumer organizations 414, for example.

With continued reference to FIG. 3, the exchange system 300 can provide one or more of the following features according to one or more embodiments described herein. The exchange system 300 can provide for onboarding more consumer organizations for the predictions by providing improved accuracy of predictions so that expert agents can achieve higher returns. The exchange system 300 can provide for facilitating feature trading among expert agents to encourage sharing private data to improve prediction accuracy and therefore KPI/profit for consumer organizations and the participating multiple expert agents. The exchange system 300 can provide for timeseries prediction by bringing together expert agents from different organizations to produce accurate predictions that were not possible with individual expert agents generating predictions independently. The exchange system 300 can provide for an increase of the overall profit for consumer organizations and the passed-on profit of each participating expert agent over the period of time.

According to one or more embodiments described herein, a method is provided to set the dynamic prices of datasets (e.g., the private data 332) that are privately owned by expert agents 330 or by the respective organization (e.g., the facilitator organization 302) based on the importance/impact of the dataset in the prediction. The dynamic prices of the datasets can be published, such as each time the exchange system 300 opens for trading. According to one or more embodiments described herein, for every expert agent, a dynamic reputation score can be computed based on the historic accuracies of the agent's prediction in current prediction problem. Also or alternatively, based on all the prediction tasks for which the expert agent has been involved the past, an overall reputation score for the agent can be computed and published in the exchange system 300 so that the facilitator organization 302 can decide whether to allow an agent (e.g., one of the expert agents 330) to participate in the prediction task based on the historical reputation score for that agent.

According to one or more embodiments described herein, a method is provided for an expert agent to decide which features to procure from other expert agents to improve the expert agent's own prediction accuracy. According to one or more embodiments described herein, a method is provided to have multiple rounds of knowledge trading to select/discard knowledge elements to reach to stability. According to one or more embodiments described herein, a method is provided to dynamically allocate returns to expert agents to encourage collaboration among them.

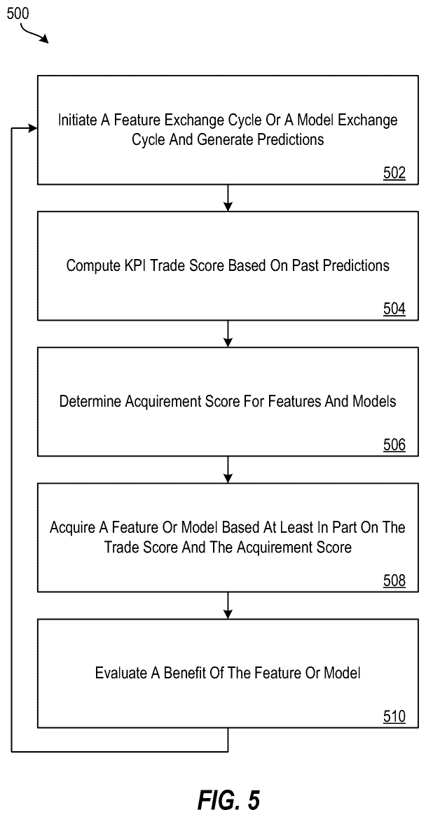

Turning now to FIG. 5, a flow diagram of a method 500 for dataset and model exchange for machine learning prediction is provided according to one or more embodiments described herein. The method 500 can be performed by any suitable device or system, such as the computing environment 100 of FIG. 1, the exchange system 300 of FIG. 3, and/or the like, including combinations and/or multiples thereof.

At block 502, a feature exchange cycle or a model exchange cycle is initiated. As used herein, a feature can include a dataset or a portion of a dataset. This marks a starting point in time T₀. According to one or more embodiments described herein, initiating the feature exchange cycle or the model exchange cycle includes announcing, publishing, or otherwise making available a prediction task and KPI information. Each of a plurality of participant agents (e.g., the expert agents 330) generates predictions until a next point in time (e.g., T₁). That is, a plurality of prediction results are generated for each participant agent using that participant agent's own one or more models and/or one or more data sets. The predictions from each of the participant agents are received by the collaborative prediction platform 310.

At block 504, based on the predictions, a KPI trade score is computed. The KPI trade score is an indication of a value associated with KPI information and a prediction result for each agent. As an example, the KPI trade score can be a profit value that can be realized for the particular participant agent.

At block 506, an acquirement score is determined for the features or models. According to one or more embodiments described herein, determining the acquirement score is performed for each participant's features or models using the trade score from block 504. According to one or more embodiments described herein, the acquirement score is a price or cost associated with acquiring the features or models. In an example, the acquirement score can be a function of an importance of the feature or model and a profit associated with implementing the acquired feature or model. According to one or more embodiments described herein, portions of the features or models can be encrypted or otherwise protected to preserve sensitive data, such as feature name.

At block 508, the feature or model is acquired from one or more of the participant agents (e.g., the expert agents 330). Acquiring features/models can include the exchange of payment or other remuneration and can be based, for example, on budget, prediction accuracy, important of the feature or model, acquirement score for the feature or model, KPI trade score for the feature or model, and/or the like, including combinations and/or multiples thereof. According to one or more embodiments described herein, portions of the features or models can be encrypted or otherwise protected while acquiring the feature or model to preserve sensitive data, such as feature name.

According to one or more embodiments described herein, the acquirement score for the feature or model can then be published or otherwise made available to the participants (e.g., expert agents) to facilitate trading/exchange of the feature or model.

At block 510, the benefit of the acquired feature or model is evaluated. For example, the benefit of the feature exchange or model exchange is evaluated against the scenario of if the feature or model was not acquired. That is, a prediction can be generated both without (at time T₀) and with (at time T₁) the acquired feature or model to determine whether the acquired feature or model provided improvement in the prediction. For example, at time T₁ an expert may decide not to procure the feature or model if the feature or model was not shown to provide a desired improvement in the prediction.

Additional processes also may be included, and it should be understood that the process depicted in FIG. 5 represents an illustration, and that other processes may be added or existing processes may be removed, modified, or rearranged without departing from the scope of the present disclosure.

Feature exchange is now described in more detail with reference to FIG. 3. Feature exchange involves the exchange of features of partial datasets that may be owned by others, such as expert agents 330. In some cases, feature exchange can include the exchange of part or all of a data (e.g., the private data 332). When expert agents (e.g., the expert agents 330) come together and in an effective and rational way share the features/properties of privately owned data (e.g., the private data 332), then they can collaboratively come up with a more accurate individual prediction and also improve the collaborative prediction. Consider the following example.

Let there be n experts (e.g., expert agents 330) who control privately owned data (features). For expert i, let the features be {Fᵢ¹, Fᵢ², . . . , Fᵢⁿ^{ᵢ}}. First, prediction occurs. For certain time stamps, such as at T₀ starting from the beginning each expert i produces individual predictions. Next, profit based prediction is determined. At time T₀, the collaborative prediction platform 310 calculates the accuracy of the past prediction for each expert i, and the collaborative prediction platform 310 computes profit based on the KPIs and each expert's individual predictions. The profit made by each expert i, is Vᵢ, which is the amount of profit obtained by the i^{th} expert from the aggregator/orchestrator agent 312. Next, features are priced. At time T₀, the collaborative prediction platform 310 computes the feature importance for the privately owned features {Fᵢ¹, Fᵢ², . . . , Fᵢⁿ^{ᵢ}} and passes it on to the aggregator/orchestrator agent 312. The feature importance is defined as {Iᵢ¹, Iᵢ², . . . , Iᵢⁿ^{ᵢ}}. Based on this, the price of the feature Fᵢ^{j} is denoted by Pᵢ^{j}=Iᵢ^{j}×Vᵢ. The collaborative prediction platform 310 publishes the prices of privately owned features by expert i along with their respective importance scores. Next, buying of features occurs. Expert i evaluates which privately owned feature to procure from the other expert agents, if any. It can be assumed that expert i has a threshold price Kᵢ below which the agent wants to procure a feature, if any. Let the set of such potential features be {H₁, H₂, . . . , Hₖ} collected across the rest of the expert agents. If expert i is trying to procure feature Hᵢ at a price Pₗ from expert j, expert i computes the effectiveness of feature Hₗ as Eₗ=(Iₗ×Reputation of expert j)/Pₗ where Iₗ is the important of feature Hₗ and reputation of expert j is computed as

$$\frac{\frac{1}{{R}_{j}^{{T}_{0}}}}{\sum 1 / {R}_{i}^{{T}_{0}}} .$$

Expert i procures the feature that has maximum effectiveness, for example. Next, after feature exchange, once each expert has decided which feature to procure from other expert agents, if any, the experts pay for the feature procured until the time point T₁, when again the feature exchange can take place. That is, a new feature exchange cycle can occur. The effectiveness of the procured feature can then be evaluated. For example, each expert at time point T₁ evaluates whether the procured features from the last feature exchange provided to be more effective by returning more profit or producing higher accuracy predictions as compared to if the feature exchange did not occur. If the feature exchange was not deemed to be effective (e.g., did not satisfy a certain threshold), the expert may stop procuring that feature in the future.

Model exchange is now described in more detail with reference to FIG. 3. Model exchange involves the exchange of models (e.g., previously trained machine learning models) that may be owned by others, such as expert agents 330. In some cases, model exchange can include the exchange of part or all of a model (e.g., the private data 332). Experts may also share models with other agents, much like feature exchange. Consider the following example.

Let there be n collaborators. Expert i has models {Mᵢ¹, Mᵢ², . . . , Mᵢⁿ^{ᵢ}}. First, prediction occurs. For a certain time steps, say T₀ starting from the beginning each expert i produced individual predictions. However, each expert i uses multiple models {Mᵢ¹, Mᵢ², . . . , Mᵢⁿ^{ᵢ}} and reports the results based on that model Mᵢ^{best}∈{Mᵢ¹, Mᵢ², . . . , Mᵢⁿ^{ᵢ}} which produced lowest running root-mean-square error (RMSE). Next, profit based on prediction is determined. At time T₀, the platform calculates the accuracy of the past prediction for each expert i, and the platform computes the profit based on the KPIs and each expert's individual predictions. Let the profit be Vᵢ^{best}. However, the platform also calculates what would have been the profit if each of the other models {Mᵢ¹, Mᵢ², . . . , Mᵢⁿ^{ᵢ}} would have been used instead. Let the profit of KPIs based on each of these models for expert i be {Vᵢ¹, Vᵢ², . . . , Vᵢⁿ^{ᵢ}}. Note that, Vᵢ^{best}∈{Vᵢ¹, Vᵢ², . . . , Vᵢⁿ^{ᵢ}}. Also, the RMSE corresponding to each of models {Mᵢ¹, Mᵢ², . . . , Mᵢⁿ^{ᵢ}} are respectively {Rᵢ¹, Rᵢ², . . . , Rᵢⁿ^{ᵢ}}. Next, pricing of the model is performed. The platform computes prices of the model Mᵢ^{j} as Pᵢ^{j}=Vᵢ^{j}−Vᵢ^{worst}. The platform also computes effectiveness of each of the model Mᵢ^{j} by computing

$$\frac{\frac{1}{{R}_{i}^{j}}}{\sum 1 / {R}_{i}^{k}}$$

and reports both the prices of the models and effectiveness of the models. Next, buying of models occurs. An expert i may have a threshold price Kᵢ below which the expert wants to buy a model if any. Let the set of all such models be {O₁, O₂, . . . , Oₖ} across rest of the collaborators. The prices and effectiveness for these set of models be denoted by {P₁, P₂, . . . , Pₖ} and {E₁, E₂, . . . , Eₖ} respectively. Expert i chooses that model for which

$$\frac{{E}_{j}}{{P}_{j}} , j ∈ \{ 1 , 2 , … , k \}$$

is maximum, for example. Next, after model exchange, once each expert has decided which model (if any) to procure from other collaborators, the experts pay for the model procured till the time point T₁ when again the model exchange can occur. The effectiveness of the procured model can then be evaluated. For example, each expert at time point T₁ evaluates whether the procured model from the last feature exchange provided to be more effective by returning more profit or producing higher accuracy predictions as compared to if the model exchange did not occur. If the model exchange was not deemed to be effective (e.g., did not satisfy a certain threshold), the expert may stop procuring that model in the future.

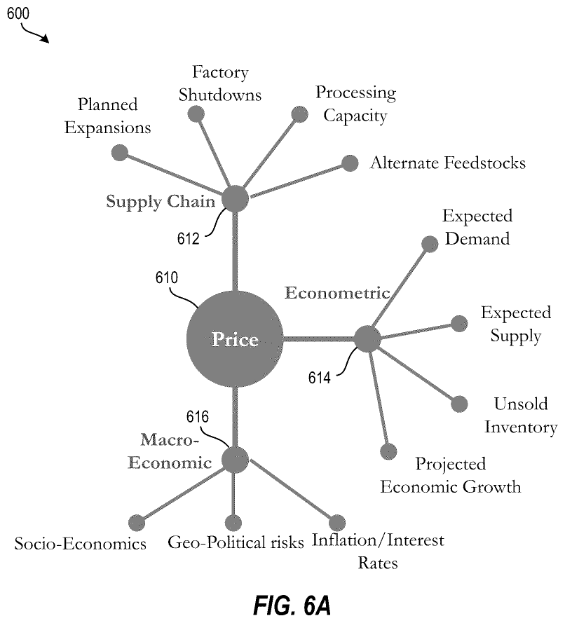

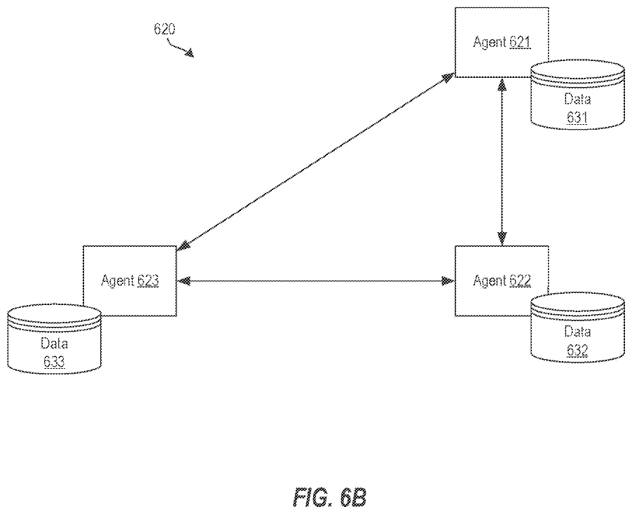

FIG. 6A depicts an example ecosystem 600 for price prediction using the collaborative prediction platform 310 of FIG. 3 according to one or more embodiments described herein. In this example, a price 610 is determined based on factors such as supply chain factors 612, econometric factors 614, and macro-economic factors 616, and their respective sub-factors, as shown.

FIG. 6B depicts an example ecosystem 620 for contingent labor involving three agents according to one or more embodiments described herein. The ecosystem 620 includes an agent 621, an agent 622, and an agent 623. In this example, an agent 621 is a sourcing specialist that can provide supply chain factors 612, the agent 622 is a labor market analysist that can provide econometric factors 614, and the agent 623 is an economist that can provide macro-economic factors 616. For example, each of the agents 621, 622, 623 can store data 631, 632, 633, respectively, with the factors (e.g., the supply chain factors 612, the econometric factors 614, and the macro-economic factors 616, respectively). The data 631, 632, 633 can include public data, private data, and/or data being explored. As an example, the data 631 can include historical procurements and alternate skills as private data and suppliers and client accounts, which can be public and/or private data. The data 632 can include unemployment rate as public data, skills demand, market scarcity index (SVF), and historical procurements as private data, and skills supply and reskilling requirements as data being explored. The data 633 can include cost of living, US dollar rates, gross domestic product, and crude oil prices as public data and historical procurements as private data.

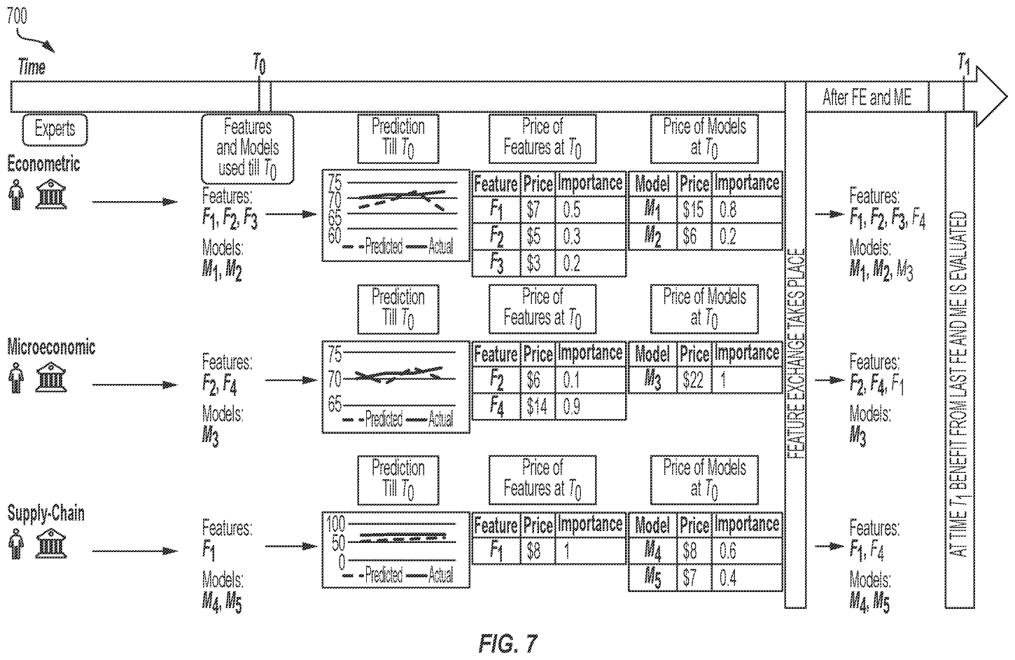

The data 631, 632, 633 can be used for feature exchange according to the example embodiment shown in FIG. 7. In particular, FIG. 7 shows an example 700 for feature exchange according to one or more embodiments described herein.

In the example of FIG. 7, the experts (e.g., the agents 621, 622, 623) are predicting the price of a job-role-skill-set (JRSS). The agent 621 used the following features: skill availability density, popularity quotient of a skill, GDP. The agent 621 used the following models: ARMA, non-linear regression. The agent 622 used the following features: popularity quotient of a skill, past price of a skill in time series. The agent 622 used the following model: ARIMAX. The agent 623 used the following feature: skill availability density. The agent 623 used the following models: linear regression and non-linear regression. The results are as follows:

Before feature exchange and model exchange, agent 621 was having an RMSE of 10.6. After feature exchange and model exchange, the RMSE reduced to 5.2. Before feature exchange and model exchange, agent 622 was having an RMSE of 5.6. After feature exchange and model exchange, the RMSE reduced to 5.3. Before feature exchange and model exchange, agent 623 was having an RMSE of 16.8. After feature exchange and model exchange, the RMSE reduced to 12.1

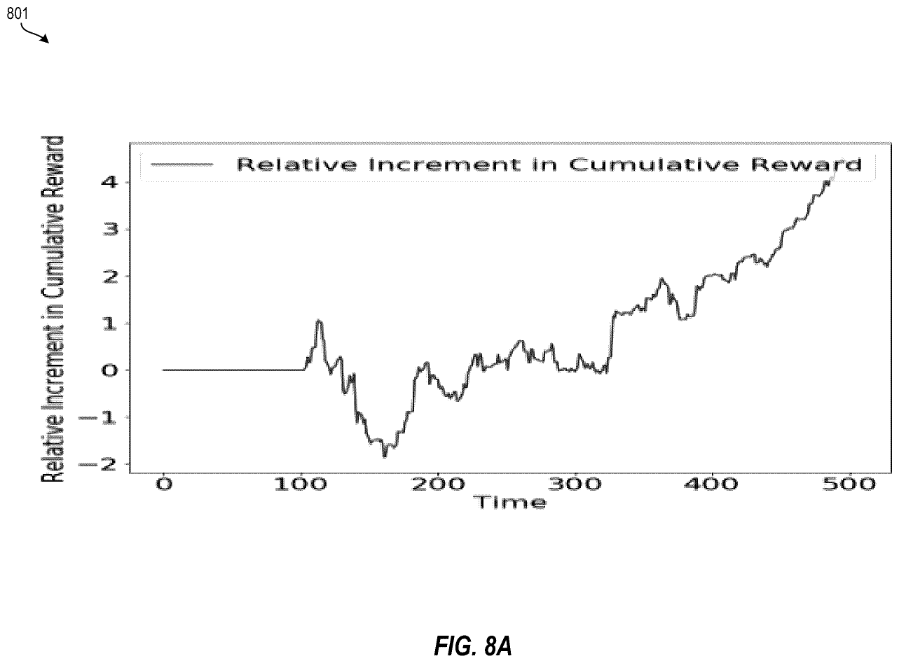

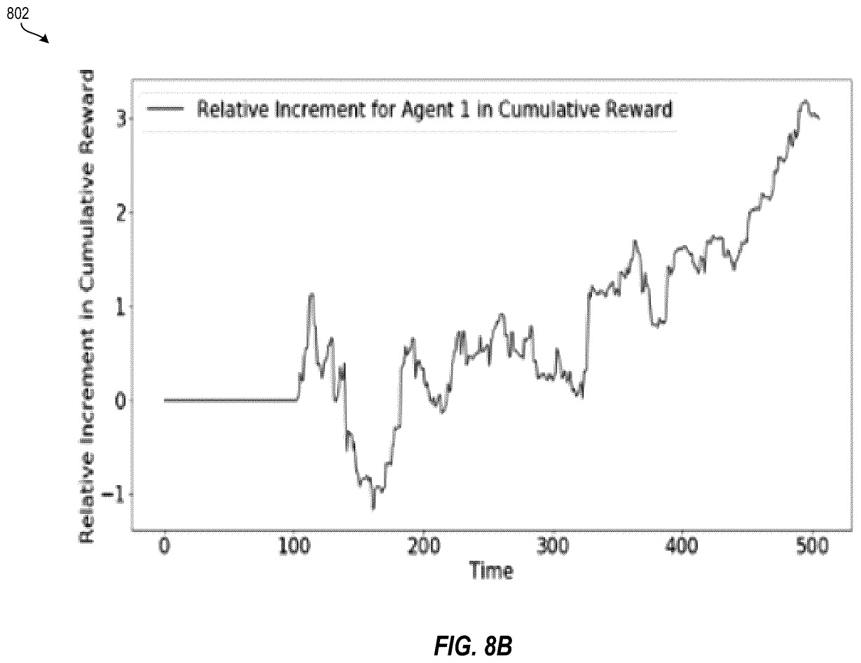

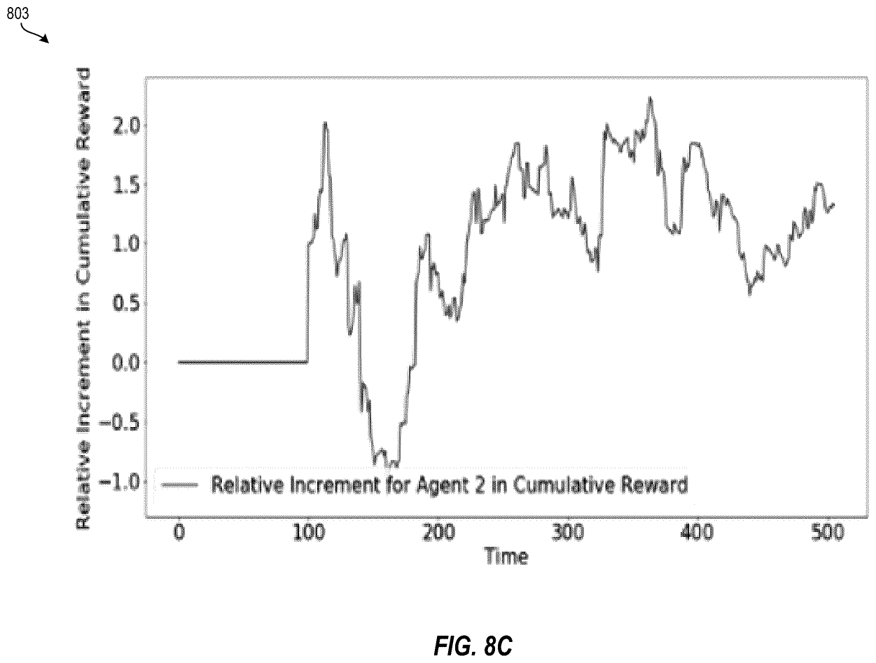

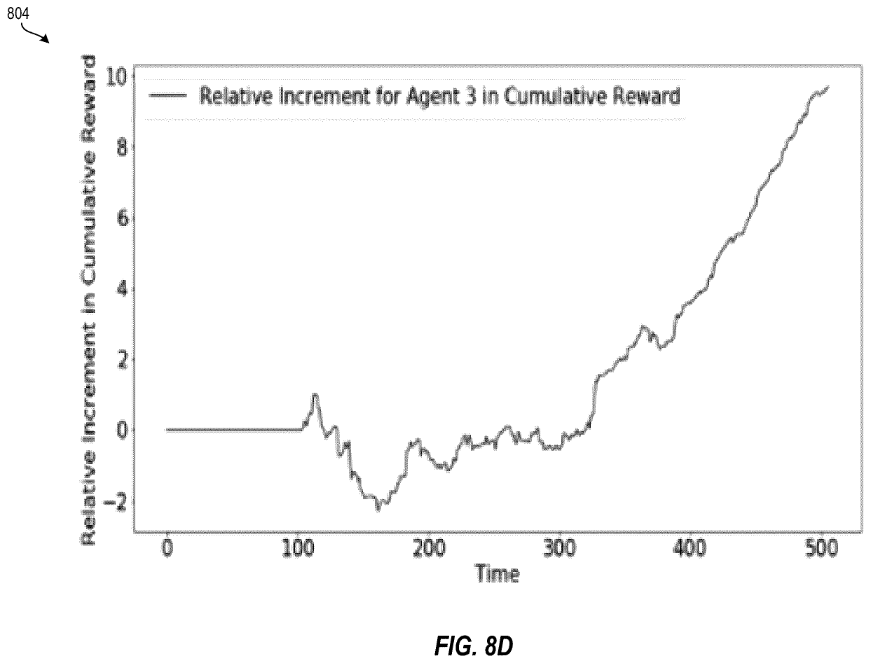

FIGS. 8A, 8B, 8C, and 8D depict example graphs 800, 801, 802, 803 according to one or more embodiments described herein. The graph 800 shows relative change increment in cumulative reward for a consumer organization when feature exchange is used compared to not using the feature exchange. That is, the difference between the cumulative reward realized over a period of time after feature exchange and the cumulative reward that would have been realized without feature exchange as shown in the graph 800. The graphs 801, 802, 803, respectively, show the relative increment for the agents 621, 622, 623 in cumulative reward when feature exchange is used as to compared to not using feature exchange.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for collaborative exchange, the method comprising:
publishing a prediction task and key performance indicator (KPI) information;
receiving, at a certain time, a plurality of prediction results, each of the plurality of prediction results being produced by one of a plurality of participants with one of a private model and private data association with the one of the plurality of participants;
calculating, for each of the plurality of participants, a trade score based on the KPI information and the plurality of prediction results for each of the plurality of participants;
determining an acquirement score for the one of the private model and the private data associated with each of the plurality of participants using the corresponding trade score; and
publishing the acquirement score for trading the one of the private model and the private data among the plurality of participants.

2. The computer-implemented method of claim 1, further comprising facilitating exchange of the one of the private model and the private data.

3. The computer-implemented method of claim 1, wherein the receiving, calculating, determining, and publishing are repeatedly executed.

4. The computer-implemented method of claim 1, further comprising:
calculating, for each participant, a reputation score by using historic accuracies of past predictions by the participant; and
publishing the reputation score.

5. The computer-implemented method of claim 4, wherein the trade score is further based at least in part on the reputation score.

6. The computer-implemented method of claim 1, further comprising:
aggregating the plurality of prediction results for a requestor of the prediction task; and
allocating returns to the plurality of participants.

7. The computer-implemented method of claim 1, wherein at least a portion of the one of the private model and the private data is encrypted.

8. A system comprising:
a memory comprising computer readable instructions; and
a processing device for executing the computer readable instructions, the computer readable instructions controlling the processing device to perform operations for collaborative exchange, the operations comprising:
publishing a prediction task and key performance indicator (KPI) information;
receiving, at a certain time, a plurality of prediction results, each of the plurality of prediction results being produced by one of a plurality of participants with one of a private model and private data association with the one of the plurality of participants;
calculating, for each of the plurality of participants, a trade score based on the KPI information and the plurality of prediction results for each of the plurality of participants;
determining an acquirement score for the one of the private model and the private data associated with each of the plurality of participants using the corresponding trade score; and
publishing the acquirement score for trading the one of the private model and the private data among the plurality of participants.

9. The system of claim 8, wherein the operations further comprise facilitating exchange of the one of the private model and the private data.

10. The system of claim 8, wherein the receiving, calculating, determining, and publishing are repeatedly executed.

11. The system of claim 8, wherein the operations further comprise:
calculating, for each participant, a reputation score by using historic accuracies of past predictions by the participant; and
publishing the reputation score.

12. The system of claim 11, wherein the trade score is further based at least in part on the reputation score.

13. The system of claim 8, wherein the operations further comprise:
aggregating the plurality of prediction results for a requestor of the prediction task; and
allocating returns to the plurality of participants.

14. The system of claim 8, wherein at least a portion of the one of the private model and the private data is encrypted.

15. A computer program product comprising a computer readable storage medium having program instructions embodied therewith, the program instructions executable by a processor to cause the processor to perform operations comprising:
publishing a prediction task and key performance indicator (KPI) information;
receiving, at a certain time, a plurality of prediction results, each of the plurality of prediction results being produced by one of a plurality of participants with one of a private model and private data association with the one of the plurality of participants;
calculating, for each of the plurality of participants, a trade score based on the KPI information and the plurality of prediction results for each of the plurality of participants;
determining an acquirement score for the one of the private model and the private data associated with each of the plurality of participants using the corresponding trade score; and
publishing the acquirement score for trading the one of the private model and the private data among the plurality of participants.

16. The computer program product of claim 15, wherein the operations further comprise facilitating exchange of the one of the private model and the private data.

17. The computer program product of claim 15, wherein the receiving, calculating, determining, and publishing are repeatedly executed.

18. The computer program product of claim 15, wherein the operations further comprise:
calculating, for each participant, a reputation score by using historic accuracies of past predictions by the participant; and
publishing the reputation score.

19. The computer program product of claim 18, wherein the trade score is further based at least in part on the reputation score.

20. The computer program product of claim 15, wherein the operations further comprise:
aggregating the plurality of prediction results for a requestor of the prediction task; and
allocating returns to the plurality of participants.
